(19) United States
(12) Patent Application Publication
(10) Pub. No.: US 2013/0312887 A1
(43) Pub. Date: Nov. 28, 2013

(54) PNEUMATIC TIRE

(71) Applicant: Akinori Oda, Kiyose-shi (JP)

(72) Inventor: Akinori Oda, Kiyose-shi (JP)

(73) Assignee: BRIDGESTONE CORPORATION, Chuo-ku, Tokyo (JP)

(21) Appl. No.: 13/984,187

(22) PCT Filed: Feb. 13, 2012
(86) PCT No.: PCT/JP2012/000933

§ 371 Date: Aug. 7, 2013

(30) Foreign Application Priority Data
Mar. 1, 2011 (JP) 2011-044044

(51) Int. Cl. B60C 11/03

(52) U.S. Cl. CPC B60C 11/03
USPC 152/209.8; 152/209.18

(57) ABSTRACT

The present invention relates to a pneumatic tire that achieves both dry performance and on-snow performance. A pneumatic tire is provided with a central land portion including the tire equator plane, intermediate land portions, and outer land portions. The central land portion is defined as a rib by a pair of central circumferential grooves and is provided with central sipes extending linearly in the tire width direction. Each intermediate land portion is divided into blocks by intermediate inclined grooves that extend obliquely with respect to the tire circumferential direction and provide communication between one of the central circumferential grooves and an outer circumferential groove, and each intermediate land portion is provided with intermediate sipes inclined at an angle of 0° to 30° with respect to the tire width direction. Each outer land portion is divided into blocks by outer inclined grooves that extend obliquely with respect to the tire circumferential direction and provide communication between an outer circumferential groove and a tread end, and each outer land portion is provided with outer sipes extending along the outer inclined grooves.

### TECHNICAL FIELD

The present invention relates to a pneumatic tire that achieves both dry performance and on-snow performance.

### BACKGROUND ART

In order to ensure acceleration performance and braking performance of a tire on snowy roads, it is known to be effective to make the tread pattern a block pattern based on lug grooves and to form a plurality of sipes extending in the tire width direction in a zigzag manner in each block (for example, JP2000229505A). Furthermore, forming each block and sipe at an inclination with respect to the tire width direction increases the width direction edge density and ensures steering stability.

### SUMMARY OF INVENTION

In the above-described conventional tire, a central land portion that includes the tire equatorial plane is a rib that is continuous in the tire circumferential direction, yet transverse grooves inclined with respect to the tire circumferential direction are formed so as to cut into the central land portion to near the tire equatorial plane. Hence, there is room for improvement in the circumferential direction rigidity of the central land portion.

Furthermore, the sipes formed in intermediate land portions on each side of the central land portion in the tire width direction are generally parallel to the inclination direction of the blocks in the intermediate land portions. In other words, the sipes are inclined with respect to the tire width direction, and thus there is room for improvement in the width direction rigidity of the intermediate land portions.

If the rigidity of the central land portion and the intermediate land portions is insufficient in this way, it may not be possible to ensure sufficient steering stability.

Therefore, it is an object of the present invention to provide a pneumatic tire with excellent steering stability on dry roads and snowy roads by both enhancing land portion rigidity and ensuring width direction edge density.

A summary of the present invention is as follows.

(1) A pneumatic tire comprising a central land portion including a tire equatorial plane, an intermediate land portion on each side of the central land portion in a tire width direction, a pair of central circumferential grooves extending continuously in a tire circumferential direction each between the central land portion and a respective one of the intermediate land portions, an outer land portion on an outside of each intermediate land portion in the tire width direction, and a pair of outer circumferential grooves extending continuously in the tire circumferential direction each between a respective one of the intermediate land portions and a respective one of the outer land portions, wherein the central land portion is defined as a rib by the pair of central circumferential grooves and is provided with a plurality of central sipes extending linearly in the tire width direction, each intermediate land portion is divided into blocks by a plurality of intermediate inclined grooves extending obliquely with respect to the tire circumferential direction and providing communication between one of the central circumferential grooves and one of the outer circumferential grooves, and each intermediate land portion is provided with a plurality of intermediate sipes inclined at an angle of 0° to 30° with respect to the tire width direction, and each outer land portion is divided into blocks by a plurality of outer inclined grooves extending obliquely with respect to the tire circumferential direction and providing communication between one of the outer circumferential grooves and a tread end, and each outer land portion is provided with a plurality of outer sipes extending along the outer inclined grooves.

(2) The pneumatic tire according to (1), wherein the central circumferential grooves extend in the tire circumferential direction in a zigzag manner.

(3) The pneumatic tire according to (1) or (2), wherein an inclination angle of the intermediate inclined grooves with respect to the tire width direction is from 5° to 85°.

(4) The pneumatic tire according to any one of (1) through (3), wherein an inclination angle of the outer inclined grooves with respect to the tire width direction is from 5° to 45°.

(5) The pneumatic tire according to any one of (1) through (4), wherein the blocks in each intermediate land portion are longer in the tire circumferential direction than in the tire width direction, and the blocks in each outer land portion are shorter in the tire circumferential direction than in the tire width direction.

### BRIEF DESCRIPTION OF DRAWINGS

The present invention will be further described below with reference to the accompanying drawings, wherein:

FIG. 1 illustrates the tread pattern of a pneumatic tire according to Embodiment 1 of the present invention; and

FIG. 2 illustrates the tread pattern of a pneumatic tire according to Embodiment 2 of the present invention.

### DESCRIPTION OF EMBODIMENTS

The following describes a pneumatic tire according to the present invention in detail with reference to the drawings.

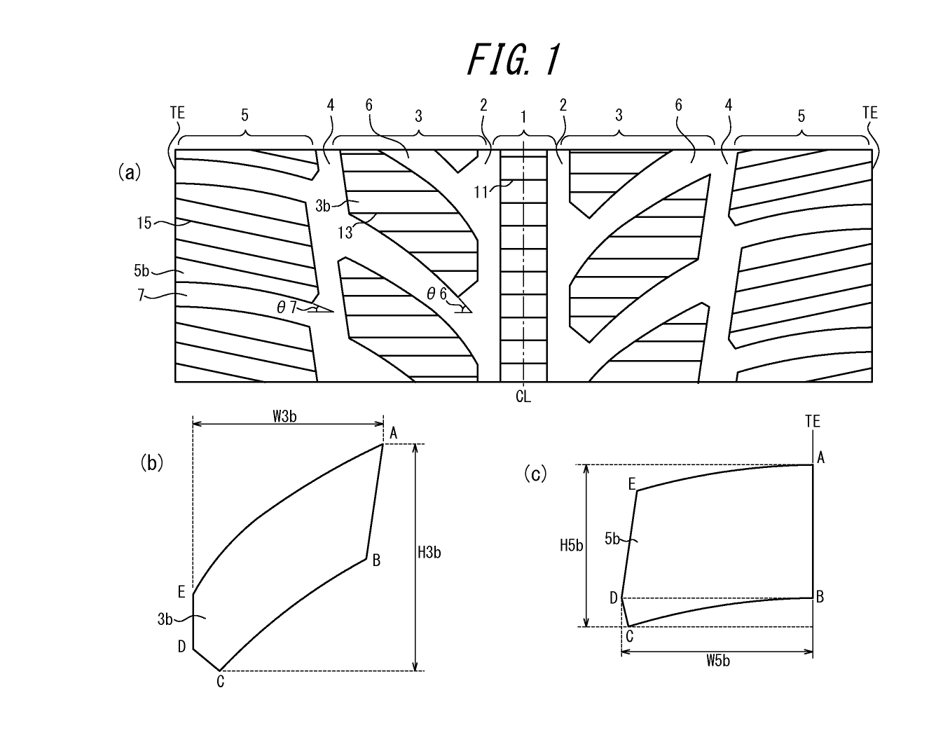

As shown in FIG. 1(a), the tread pattern of a pneumatic tire according to Embodiment 1 of the present invention is provided with a central land portion 1 including a tire equatorial plane CL, an intermediate land portion 3 on each side of the central land portion 1 in the tire width direction, a pair of central circumferential grooves 2 extending continuously in the tire circumferential direction each between the central land portion 1 and a respective one of the intermediate land portions 3, an outer land portion 5 on an outside of each intermediate land portion 3 in the tire width direction, and a pair of outer circumferential grooves 4 extending continuously in the tire circumferential direction each between a respective one of the intermediate land portions 3 and a respective one of the outer land portions 5.

The central land portion 1 is defined as a rib by the pair of central circumferential grooves 2. This rib-shaped central land portion 1 is provided with a plurality of central sipes 11 extending linearly in the tire width direction.

Each intermediate land portion 3 is divided into blocks 3b by intermediate inclined grooves 6 that extend obliquely with respect to the tire circumferential direction and provide communication between one of the central circumferential grooves 2 and one of the outer circumferential grooves 4. Each block 3b is provided with a plurality of intermediate sipes 13 extending linearly in the tire width direction.

Each outer land portion 5 is divided into blocks 5b by a plurality of outer inclined grooves 7 that extend obliquely with respect to the tire circumferential direction and provide communication between one of the outer circumferential grooves 4 and a tread end TE. Each block 5b is provided with a plurality of outer sipes 15 extending along the outer inclined grooves 7.

As shown by the enlarged view in FIG. 1(b) of a block 3b in the intermediate land portion 3, each block 3b has a vertically long shape. In other words, the height H3b of the block 3b in the tire circumferential direction (the distance between line segments extending parallel to the tire width direction from vertices A and C, which are the vertices most separated in the tire circumferential direction when the vertices of the block 3b are A, B, C, D, and E) is greater than the width W3b of the block 3b in the tire width direction (the distance between line segments extending parallel to the tire circumferential direction from vertex A and vertices D and E, which are the vertices most separated in the tire width direction).

As shown by the enlarged view in FIG. 1(c) of a block 5b in the outer land portion 5, each block 5b has a horizontally long shape. In other words, the height H5b of the block 5b in the tire circumferential direction (the distance between line segments extending parallel to the tire width direction from vertices A and C, which are the vertices most separated in the tire circumferential direction when the vertices of the block 5b are A, B, C, D, and E) is less than the width W5b of the block 5b in the tire width direction (the distance from vertex D, the innermost vertex in the tire width direction, to the tread end TE).

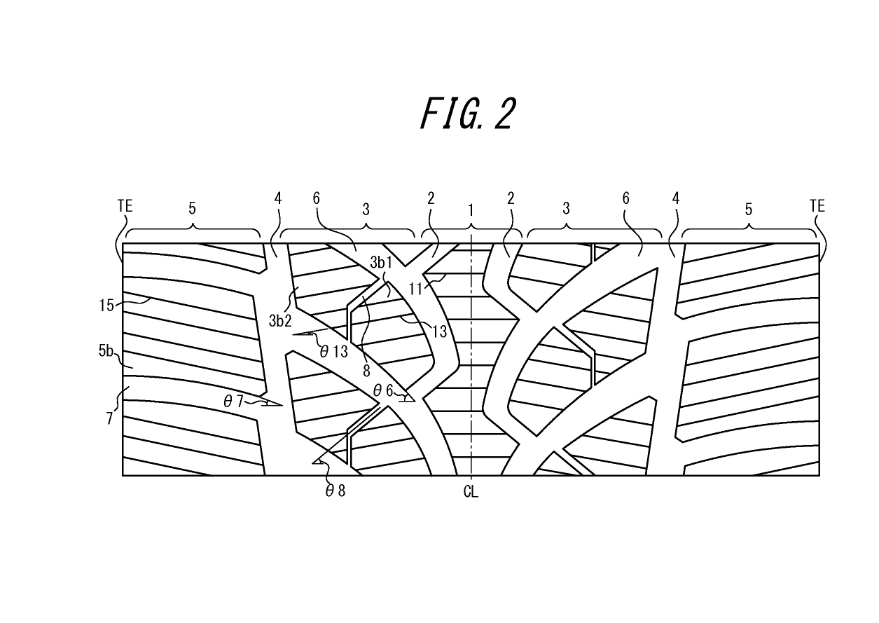

FIG. 2 illustrates the tread pattern of a pneumatic tire according to Embodiment 2 of the present invention. In Embodiment 2, constituent elements that are the same as Embodiment 1 are provided with the same reference signs, and a description thereof is omitted.

The central circumferential grooves 2 extend in the tire circumferential direction in a zigzag manner, and the groove walls of the central land portion 1 also extend in the tire circumferential direction in a zigzag manner.

Each intermediate land portion 3 is divided into blocks 3b1 and 3b2 by an intermediate inclined narrow groove 8 that is inclined in the opposite direction as the inclination direction with respect to the tire circumferential direction of the intermediate inclined grooves 6 and that communicates with the intermediate inclined grooves 6. It is essential that the sipes 13 formed in the blocks 3b1, 3b2 be inclined with respect to the tire width direction, and that an inclination angle θ13 with respect to the tire width direction be from 0° to 30°.

The following describes the operations and effects of the present invention.

Forming sipes throughout the land portions allows for enhancement of on-snow performance and on-ice performance. Specifically, the sipes achieve an edge effect on a snowy surface and achieve both an edge effect and a water layer removal effect on an icy surface.

Forming the central land portion 1 as a rib can increase the circumferential direction rigidity as compared to when the central land portion 1 is formed as blocks.

Forming the blocks 3b of each intermediate land portion 3 to be vertically long can increase the circumferential direction rigidity as compared to when the blocks 3b are horizontally long.

The circumferential direction rigidity of the central land portion 1 and each intermediate land portion 3 can thus be increased, yet the width direction rigidity is low. Therefore, by forming the central sipes 11 of the central land portion 1 to extend linearly along the tire width direction and forming the intermediate sipes 13 of the intermediate land portions 3 to be inclined with respect to the tire width direction at a relatively small angle of 0° to 30°, the reduction in the width direction rigidity of the land portions is suppressed to a minimum, thereby preventing a loss of steering stability.

Furthermore, since the central sipes 11 extending linearly in the tire width direction and the intermediate sipes 13 inclined at a small angle with respect to the tire width direction increase the edge component with respect to the tire circumferential direction, both on-snow braking performance and on-snow acceleration performance can be ensured.

Forming the blocks 5b of each outer land portion 5 to be horizontally long can increase the width direction rigidity as compared to when the blocks 5b are vertically long. Since the width direction rigidity of the blocks 5b in the outer land portions 5 is thus increased, the necessary width direction rigidity can be maintained even when the outer sipes 15 in the outer land portions 5 extend obliquely with respect to the tire circumferential direction by being formed along the outer inclined grooves 7 that extend obliquely with respect to the tire circumferential direction.

Furthermore, since the outer sipes 15 that extend obliquely with respect to the tire circumferential direction increase the sipe edge density in the tire width direction, steering stability can be ensured.

In summary, the central land portion 1 and the intermediate land portions 3 increase the circumferential direction rigidity and the edge effect, and the outer land portions 5 ensure width direction rigidity and edge density, thereby making it possible to achieve both dry performance and on-snow performance.

In FIG. 2, by forming the groove walls of the central land portion 1 to extend in the tire circumferential direction in a zigzag manner, the edge component in the circumferential direction can be increased and snow column shear force can be enhanced as compared to the structure in FIG. 1, thus allowing for enhancement of both on-snow braking performance and on-snow acceleration performance. The reason is that by connecting the central circumferential grooves 2 and the intermediate inclined grooves 6, which have approximately equal groove widths, the on-snow braking/driving performance is enhanced.

Furthermore, by providing the intermediate inclined narrow groove 8, the drainage performance can be increased as compared to the structure in FIG. 1. In order to enhance the on-snow steering stability, an inclination angle θ8 of the intermediate inclined narrow groove 8 with respect to the tire width direction is preferably from 15° to 85°.

In order to ensure the on-snow steering stability, an inclination angle θ6 of the intermediate inclined grooves 6 with respect to the tire width direction is preferably from 5° to 85°.

When the inclination angle θ6 is less than 5° or greater than 85°, the edge effect achieved by the blocks 3b in each intermediate land portion 3 may be insufficient. Additionally, if the inclination angle θ6 is less than 5°, greater tire noise and worse on-ice performance become cause for concern. On the other hand, if the inclination angle θ6 is greater than 85°, the blocks 3b may suffer uneven wear.

In order to ensure the on-snow steering stability, an inclination angle θ7 of the outer inclined grooves 7 with respect to the tire width direction is preferably from 5° to 45°.

If the inclination angle θ7 is less than 5°, the edge effect achieved by the blocks 5b in each outer land portion 5 may be insufficient, and greater tire noise and worse on-ice performance also become cause for concern. On the other hand, if the inclination angle θ7 is greater than 45°, the blocks 5b may suffer uneven wear.

Note that in FIG. 1(a) and FIG. 2, the central sipes 11 extend at an inclination angle of 0° with respect to the tire width direction, yet the case of inclination within a range of ±1° with respect to the tire width direction is also included in the present invention.

Similarly, the outer sipes 15 extend in parallel to the outer inclined grooves 7, yet the case of inclination within a range of ±1° with respect to the outer inclined grooves 7 is also included in the present invention.

### Examples

The following describes examples of the present invention, yet the present invention is not limited to these examples.

Inventive example tires and a comparative example tire (tire size: 195/65R15) were produced, and under the conditions listed in Table 1, horizontal block rigidity, acceleration performance, and steering stability were assessed, as described below.

Inventive example tire 1 has the specifications listed in Table 2 and the tread pattern illustrated in FIG. 2. The inclination angle θ6 of the intermediate inclined grooves 6 with respect to the tire width direction varies between 20° and 50°, and the inclination angle θ7 of the outer inclined grooves 7 with respect to the tire width direction varies between 5° and 25°. The outer sipes 15 extend along the outer inclined grooves 7.

Inventive example tire 2 has the tread pattern illustrated in FIG. 1(a) and is the same as inventive example tire 1 except that the central circumferential grooves 2 are linear and the intermediate inclined narrow groove 8 is not formed.

Inventive example tire 3 has the tread pattern illustrated in FIG. 2 and is the same as inventive example tire 1 except that the inclination angle θ13 of the intermediate sipes 13 with respect to the tire width direction is 0°.

Inventive example tire 4 has the tread pattern illustrated in FIG. 2 and is the same as inventive example tire 1 except that the inclination angle θ13 of the intermediate sipes 13 with respect to the tire width direction is 30°.

Inventive example tire 5 has the tread pattern illustrated in FIG. 2 and is the same as inventive example tire 1 except that the inclination angle θ8 of the intermediate inclined narrow groove 8 with respect to the tire width direction is 90°.

Inventive example tire 6 has the tread pattern illustrated in FIG. 2 and is the same as inventive example tire 1 except that the inclination angle θ6 of the intermediate inclined grooves 6 with respect to the tire width direction is 0°.

Inventive example tire 7 has the tread pattern illustrated in FIG. 2 and is the same as inventive example tire 1 except that the inclination angle θ7 of the outer inclined grooves 7 with respect to the tire width direction is 0°.

The comparative example tire is the same as inventive example tire 1 except that the inclination angle θ13 of the intermediate sipes 13 with respect to the tire width direction is −16°. In other words, the intermediate sipes 13 are inclined in the same direction as the intermediate inclined grooves 6.

TABLE 1

| | |
|---|---|
| Internal pressure | 230 kPa |
| Vehicle | FR vehicle (2500 cc displacement) |
| Load | One driver + 60 kg (equivalent to |
| | two passengers) |

### Horizontal Block Rigidity

Blocks were cut from each sample tire, a load equivalent to the tire pressure on the block area was applied, and the force produced in the horizontal direction when the block or the tire ground contact area was moved 1 mm was measured. The results are indicated as an index, with the horizontal block rigidity of inventive example tire 1 as 100. Note that a larger index indicates higher horizontal block rigidity.

### On-Snow Acceleration Performance

Each sample tire was mounted on a vehicle, and after starting on a test course with a snowy road surface, the acceleration time from a velocity of 10 km/h to 35 km/h was measured. The results are indicated as an index, with the acceleration time of inventive example tire 1 as 100. Note that a larger index indicates superior acceleration performance.

### Steering Stability

Each sample tire was mounted on a vehicle and run at a constant velocity (80 km/h) on a test course with a snowy road surface and a dry road surface.

The steering stability was assessed according to the feeling of a professional driver. The results of assessments are indicated on a scale of 1 to 10. A larger value indicates superior steering stability.

TABLE 2

| | | | | | | | | On-Snow | Dry |
|---|---|---|---|---|---|---|---|---|---|
| | Tread | | | | | Horizontal Block | On-Snow Acceleration | Steering | Steering |
| | Pattern | θ6 (°) | θ7 (°) | θ8 (°) | θ13 (°) | Rigidity | Performance | Stability | stability |
| Comparative | FIG. 2 | 20-50 | 5-25 | 50 | −16 | 90 | 90 | 5.5 | 6.0 |
| Example | | | | | | | | | |
| Inventive | FIG. 2 | 20-50 | 5-25 | 50 | 16 | 100 | 100 | 7.0 | 7.0 |
| Example 1 | | | | | | | | | |
| Inventive | FIG. | 20-50 | 5-25 | — | 16 | 88 | 83 | 5.0 | 5.5 |
| Example 2 | 1(a) | | | | | | | | |
| Inventive | FIG. 2 | 20-50 | 5-25 | 50 | 0 | 101 | 97 | 6.5 | 6.5 |
| Example 3 | | | | | | | | | |
| Inventive | FIG. 2 | 20-50 | 5-25 | 50 | 30 | 96 | 92 | 6.0 | 6.5 |
| Example 4 | | | | | | | | | |
| Inventive | FIG. 2 | 20-50 | 5-25 | 90 | 16 | 96 | 91 | 6.0 | 6.5 |
| Example 5 | | | | | | | | | |
| Inventive | FIG. 2 | 0 | 5-25 | 50 | 16 | 100 | 93 | 6.0 | 6.5 |
| Example 6 | | | | | | | | | |
| Inventive | FIG. 2 | 20-50 | 0 | 50 | 16 | 100 | 94 | 6.0 | 6.0 |
| Example 7 | | | | | | | | | |

Table 2 shows that the horizontal block rigidity, acceleration performance, and steering stability of the inventive example tires were equivalent to or better than those of the comparative example tire.

### REFERENCE SIGNS LIST

1: Central land portion

2: Central circumferential groove

3: Intermediate land portion

3b: Block

3b1: Block

3b2: Block

4: Outer circumferential groove

5: Outer land portion

5b: Block

6: Intermediate inclined groove

7: Outer inclined groove

8: Intermediate inclined narrow groove

11: Central sipe

12: Third lug groove

13: Intermediate sipe

131: Intermediate sipe

132: Intermediate sipe

15: Outer sipe

CL: Tire equatorial plane

TE: Tread end

1. A pneumatic tire comprising a central land portion including a tire equatorial plane, an intermediate land portion on each side of the central land portion in a tire width direction, a pair of central circumferential grooves extending continuously in a tire circumferential direction each between the central land portion and a respective one of the intermediate land portions, an outer land portion on an outside of each intermediate land portion in the tire width direction, and a pair of outer circumferential grooves extending continuously in the tire circumferential direction each between a respective one of the intermediate land portions and a respective one of the outer land portions, wherein
the central land portion is defined as a rib by the pair of central circumferential grooves and is provided with a plurality of central sipes extending linearly in the tire width direction,
each intermediate land portion is divided into blocks by a plurality of intermediate inclined grooves extending obliquely with respect to the tire circumferential direction and providing communication between one of the central circumferential grooves and one of the outer circumferential grooves, and each intermediate land portion is provided with a plurality of intermediate sipes inclined at an angle of 0° to 30° with respect to the tire width direction, and
each outer land portion is divided into blocks by a plurality of outer inclined grooves extending obliquely with respect to the tire circumferential direction and providing communication between one of the outer circumferential grooves and a tread end, and each outer land portion is provided with a plurality of outer sipes extending along the outer inclined grooves.

2. The pneumatic tire according to claim 1, wherein the central circumferential grooves extend in the tire circumferential direction in a zigzag manner.

3. The pneumatic tire according to claim 1, wherein an inclination angle of the intermediate inclined grooves with respect to the tire width direction is from 5° to 85°.

4. The pneumatic tire according to claim 1, wherein an inclination angle of the outer inclined grooves with respect to the tire width direction is from 5° to 45°.

5. The pneumatic tire according to claim 1, wherein the blocks in each intermediate land portion are longer in the tire circumferential direction than in the tire width direction, and
the blocks in each outer land portion are shorter in the tire circumferential direction than in the tire width direction.
